(19) United States
(12) Patent Application Publication
(10) Pub. No.: US 2002/0111076 A1
(43) Pub. Date: Aug. 15, 2002

(54) Data-interface-controlled multiple plug

(76) Inventor: Matthias Wendt, Wuerselen (DE)

Correspondence Address: U.S. Philips Corporation, 580 White Plains Road, Tarrytown, NY, 10591, US

(21) Appl. No.: 10/071,394

(22) Filed: Feb. 6, 2002

(30) Foreign Application Priority Data
Feb. 9, 2001 (DE) 10106025.4

(51) Int. Cl. H01R 25/00; H01R 27/02; H01R 31/00; H01R 33/88; H01R 33/90; H01R 33/92; H01R 33/94

(52) U.S. Cl. 439/652

(57) ABSTRACT

The invention relates to an arrangement for supplying power to peripherals of an electronic device (1) with at least one data transfer interface. The object is achieved according to the invention in that an arrangement for supplying power to peripherals (2, 3, 4) of an electronic device (1) includes at least one data transfer interface, while the arrangement has at least one socket (14) and a mains connection plug (12) as well as a data transfer interface (10) which is provided for controlling the connection and disconnection of the socket (14).

The invention relates to an arrangement for supplying power to peripherals of an electronic device with at least one data transfer interface.

In recent years the USB (Universal Serial Bus) port has become common as a data transfer interface on computers. As well as the function of data transfer this bus also has the task of power supply for smaller connected peripherals such as e.g. scanners. The power range of the power supply is very limited, however.

JP 2000-231969 describes a device which contains a USB hub which connects several USB ports together, and a power pack which provides mains voltage and DC voltage to supply connected USB peripherals. Furthermore, a socket is provided to which a further electrical device can be connected.

It is an object of the present invention particularly to ensure the power supply to peripherals of a computer through a central power supply which can be controlled by the computer. Furthermore, the current consumption of the peripherals in standby mode should thus be reduced to zero.

The object is achieved according to the invention in that an arrangement is provided for the power supply of peripherals of an electronic device with at least one data transfer interface, in which the arrangement has at least one socket and a mains connection plug and a data transfer interface intended to control the connection and disconnection of the socket.

Such an arrangement offers the great advantage that the power supply to the peripherals of an electronic device can be controlled by the device itself.

The electronic device is usually a PC or laptop or Notebook as these devices have data transfer interfaces, but other electronic devices can also have such interfaces. These include for example set-top boxes for digital TV or digital video recorders. For example as soon as a computer is switched on, a voltage is present at the computer data transfer interface. This voltage is also present via a cable, at the data interface of the device and activates a switch. Thus the sockets present in the arrangement are switched on and the peripherals supplied with power. In this way any peripherals can be used, even those that do not have a corresponding data interface as no communication is required between the peripherals and the computer. Since the power supply arrangement is directly attached to the mains electricity supply, even high-power peripherals can easily be supplied with power. This is important because the data interfaces often used nowadays can according to the USB standard supply power to peripherals with only low electric power consumption. In addition, the peripherals are totally separated from the power network when the computer is switched off as no further voltage is then present on the switch of the power supply device and this is therefore disconnected. The mains switches of the individual peripherals therefore need no longer be activated. This increases the comfort and reduces the power consumption to zero when the computer is switched off. This is all the more significant as many peripherals no longer have a mains switch for reasons of cost and thus would constantly draw power in standby mode. This is reliably prevented with the arrangement according to the invention.

The embodiment as claimed in claim 2 is characterized in that the USB port is used as a data interface. Each modem computer, whether desktop or portable, today has such a USB port. This ensures that the arrangement according to the invention can work together with all computers available on the market.

The embodiment as claimed in claim 3 allows individual control of respective sockets. For example, there is no longer a distinction between whether or not a voltage is present at the interface, but the computer can switch the individual sockets on and off. Thus power is supplied only to the peripherals to which the computer has access then. If, for example, a print out is required, the printer is supplied with power. If, on the other hand, a drawing is scanned, only the scanner is powered. Thus the power consumption is reduced even during operation of the computer, due to selective switching of the peripherals.

The embodiment as claimed in claim 4 offers a particularly simple way of switching on the sockets. If voltage is present on the data transfer interface, a relay is activated which switches the sockets to the mains voltage. As soon as the data transfer interface no longer carries voltage, the relay switches the socket off again. Thus the sockets are enabled as soon as the computer is switched on and are disabled again when the computer is switched off. Since relays are inexpensive, economic production of the device according to the invention is possible.

If a USB port is used as a data transfer interface, the embodiment as claimed in claim 5 offers the advantage that as well as controlling the power supply, another USB peripheral can be connected to the same USB socket. Semi-conductor switches such as e.g. opto-relays or semi-conductor relays require only little control current. Thus another load can be connected to the same USB port.

With the embodiment as claimed in claim 6 individual switching of all peripherals connected to the computer is superfluous. This improves the operating comfort as the peripherals are ready for use when the computer is switched on.

The embodiments as claimed in claims 7 and 8 have the advantage that as well as controlling the power supply, at the same time cabling of the data streams is possible by means of one and the same arrangement. With several USB ports, several peripherals can communicate with the computer. This is useful as most computers only have two USB ports and therefore for several peripherals a USB distributor or USB hub is required. Such USB hubs are normally produced as a unit. Therefore in production technology it is simple to connect such a ready-made USB hub to the USB data interface of the power supply arrangement according to the invention and integrate this into the housing. Thus the USB hub and multiple socket form a unit which takes up little space and not only supplies power to all connected peripherals but also connects them to the USB port of the computer.

The power supply to high-power devices such as printers is thus ensured as otherwise they could not be supplied with sufficient power through the USB port.

The embodiment as claimed in claim 9 above all offers production advantages. The use of conventional multiple socket strips reduces costs. Furthermore, in these multiple socket strips there is almost always unused space available in which the data transfer interface with the necessary switch means can be fitted. A USB hub can also be fitted in many multiple socket strips without this increasing the overall volume.

Examples of embodiment of the present invention are now described in more detail using some Figures, in which

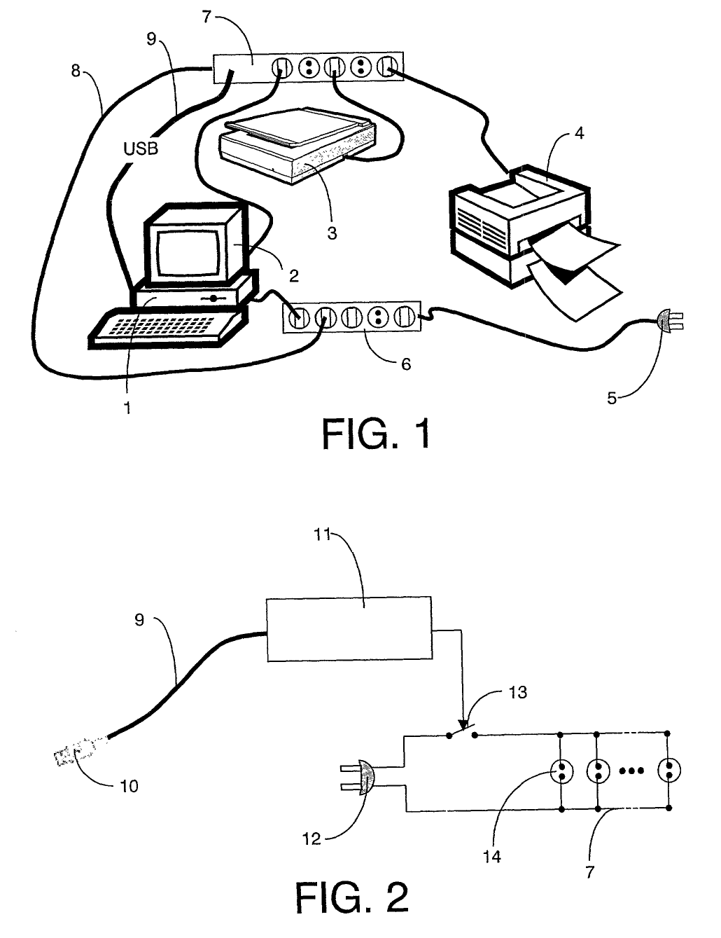

FIG. 1: shows a computer and several peripherals supplied with power via a computer-controlled socket strip,

FIG. 2: shows the structure of a socket strip computer-controlled by means of a USB port, and

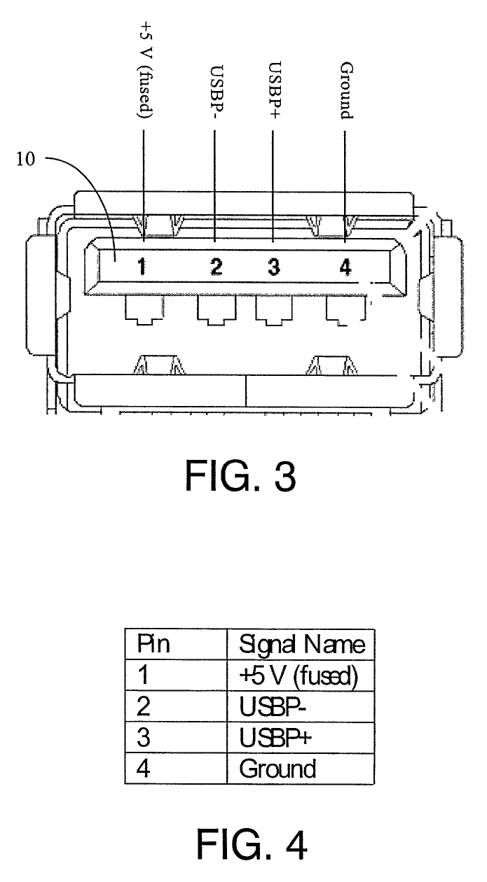

FIGS. 3 and 4: show the plug allocation of the individual pins of the USB plug.

FIG. 1 shows the principle of a socket strip 7 controlled via a data interface. Various peripherals are connected to a PC 1 via data lines. They are a monitor 2, a scanner 3 and a printer 4. As these peripherals 2, 3, 4 have a mains connection, they must be connected to the power network. For this purpose peripherals 2, 3, 4 are plugged into the new socket strip 7. This is in turn supplied by a conventional socket strip 6 via which the PC 1 is also powered. Via a mains plug 5 the conventional socket strip 6 is connected directly to the power network. This means the PC 1 and the conventional socket strip 6 are permanently connected to the electricity mains. The peripherals 2, 3, 4 are supplied with power only when the new socket strip 7 connects them. In the simplest case this is achieved when the PC 1 is switched on. Then a voltage is present at the data interface of the PC 1, here a USB port which voltage in the computer-controlled socket strip 7 switches the power to sockets 14 of peripherals 2, 3, 4. When PC 1 is switched off again, the USB port has no voltage as a result of which the socket strip 7 is switched off.

FIG. 2 shows in more detail the structure of such a computer-controlled socket strip 7 which uses the USB port as a data transfer interface. Sockets 14 for peripherals 2, 3, 4 can be isolated from the power supply 12 via a switch 13. The switch 13 is triggered by a switch component 11 known as the USB interface. This USB interface 11 has a USB connecting cable with a USB plug 10. This is connected to the USB port on the PC 1. FIGS. 3 and 4 show the pin allocation of such a USB plug 10. The two outer pins of the plug 10 are used to supply power to the connected devices which have a low power consumption. Thus for example scanner 3 can be supplied with power directly via the USB port. For monitor 2 and printer 4, however, this is not possible as they consume too much power and the maximum load on the USB port is 500 mA. Here in any case a mains connection is required. A relay is provided as switch 13. If PC 1 is now switched on, a voltage is present at the two outer pins of plug 10 and the relay switches the sockets 14 to the power supply 12. Now all peripherals 2, 3, 4 are supplied with power. If the PC is switched off again, the relay opens and the power supply to the sockets 14 is interrupted.

Instead of a relay, an opto-relay or semi-conductor switch can also be used as switch 13. They require only a low control current of around 10 mA, so that the USB port 10 is under scarcely any load and can be loaded by a further USB device. If an external USB port is provided on the socket strip 7, this external port can be connected to the further USB device while the USB signal is looped through to this device.

Instead of the one external USB port, a USB hub can be integrated into the socket strip 7 and several devices connected to the USB port, where the power is then suitably supplied via the socket 14, as via the USB port only a maximum 500 mA is available even to all devices together, which is not sufficient. Such a socket strip 7 constitutes a data distribution center with power supply center and fits into the easily modified housing of a conventional socket strip.

As an extension stage can be provided not to use the operating voltage of the two outer pins of the USB plug 10, but to use the USB signals themselves. For this purpose a decoder for USB signals is fitted in the USB interface 11. Also instead of the one switch 13, all sockets 14 of the socket strip 7 can be switched separately via the decoder as a function of the USB signals. The sockets 14 can now be switched on and off by PC 1 individually via respective software. Thus, for example, printer 4 can be switched on purposefully only when a printing process is present. This reduces the power consumption as then the printer 4 is not in standby mode when it is not required, but is switched off completely.

Instead of the USB port used in the example of embodiment, other data transfer interfaces can be used such as parallel and serial computer interfaces or the IEEE 1394 port.

1. An arrangement for supplying power to peripherals (2, 3, 4) of an electronic device (1) with at least one data transfer interface, in which the arrangement has at least one socket (14) and a mains connection plug (12) and a data transfer interface (10) which is provided for controlling the connection and disconnection of the socket (14).

2. An arrangement as claimed in claim 1, characterized in that the data transfer interface (10) is a USB port.

3. An arrangement as claimed in claim 1, characterized in that at least two sockets (14) are provided which can be switched independently via commands transferred by the data interface (10).

4. An arrangement as claimed in claim 1, characterized in that an electromagnetic relay is provided as a switch element (13) for switching the sockets (14).

5. An arrangement as claimed in claim 2, characterized in that a semi-conductor relay is provided as a switch element (13) for switching the sockets (14).

6. An arrangement as claimed in claim 1, characterized in that it is provided that the sockets (14) are switched on together when a current is flowing over the data interface (10) and switched off together when no current is flowing over the data interface (10).

7. An arrangement as claimed in claim 2, characterized in that in addition to the USB port (10) this arrangement has at least one USB port for data transfer to peripherals (2, 3, 4).

8. An arrangement as claimed in claim 2, characterized in that a USB hub is integrated in addition to the USB port (10).

9. An arrangement as claimed in claim 8, characterized in that the data transfer interface (10) and necessary switch means (11, 13) are integrated with a multiple socket strip (7).

10. System with an electronic device (1) and at least one peripheral (2, 3, 4), characterized in that power is supplied to the peripheral (2, 3, 4) via an arrangement as claimed in claim 1.
